(19) United States
(12) Patent Application Publication
(10) Pub. No.: US 2024/0260652 A1
(43) Pub. Date: Aug. 8, 2024

(54) AIRFLOW CONTROL DEVICES AND RELATED METHODS

(71) Applicant: White Rhino U.S.A., LLC, Draper, UT (US)

(72) Inventor: Adnan Afridi, Herriman, UT (US)

(21) Appl. No.: 18/165,016

(22) Filed: Feb. 6, 2023

(51) Int. Cl. A24F 9/00; A24F 5/10

(52) U.S. Cl. CPC A24F 9/00; A24F 5/10; B33Y 80/00

(57) ABSTRACT

An airflow control device may include a first body. The first body may include a first end with a first portion defining a first opening and a second end opposite the first end. The second end may include a second portion defining a second opening. Additionally, there may be a connection feature at a second end. The airflow control device may also include a plurality of second bodies configured to removably connect to the connection feature at the second end of the first body.

### TECHNICAL FIELD

The present disclosure relates generally to airflow control devices and related methods. More particularly, the present disclosure relates to airflow control devices as well as associated methods for applications such as, for example, vaporizing and/or smoking.

### BRIEF SUMMARY

Various embodiments of the disclosure relate to airflow control devices that are generally used in the context of vaporizing and/or smoking. According to some embodiments, an airflow control device may include a first body defining a fluid passageway that may extend through the first body. The first body may additionally include a first end including a first portion defining a first opening, a second end opposite the first end, the second end including a second portion defining a second opening, and a connection feature at the second end, the connection feature configured to separately connect to one of a plurality of second bodies. The airflow control device may also include one of the plurality of second bodies. In some embodiments, the plurality of second bodies may be configured to removably connect to the connection feature at the second end the first body.

According to some embodiments, the airflow control device may include a first body exhibiting a tubular shape, the first body including a first inlet, a first outlet, and a first connection feature. The airflow control device may further include one of a plurality of second bodies exhibiting a tubular shape, the second body including a second inlet, a second outlet, and a second connection feature configured to removably connect to the first connection feature.

According to some embodiments, a method of forming an airflow control device may include forming a first body. In some embodiments, the first body may include a first end defining a first opening, a second end opposite the first end which defines a second opening, and a first connection feature at the second end. Additionally, the first body may define a first fluid passageway from the first opening to the second opening. The method of forming the airflow control device may include forming a second body. In some embodiments, the second body may include a first end defining a third opening, a second end defining a fourth opening, and a second connection feature at the first end. Additionally, the second connection feature may be configured to connect to the first connection feature of the first body.

### BRIEF DESCRIPTION OF THE DRAWINGS

FIG. 1 is an elevational, exploded view of an example airflow control device in accordance with embodiments of this disclosure;

FIG. 2 is an elevational, cross-sectional view of the airflow control device of FIG. 1 in a fully assembled state, in accordance with embodiments of this disclosure;

FIG. 3 is an elevational, cross-sectional view of the first body of the airflow control device of FIG. 1, in accordance with embodiments of this disclosure;

FIG. 4 is an elevational view of an embodiment of the second body of the airflow control device of FIG. 1, in accordance with embodiments of this disclosure;

FIG. 5 is an elevational view of another embodiment of the second body of the airflow control device of FIG. 1, in accordance with embodiments of this disclosure;

FIG. 6 is an elevational view of another embodiment of the second body of the airflow control device of FIG. 1, in accordance with embodiments of this disclosure;

FIG. 7 is a perspective view of the embodiment of the second body of the airflow control device of FIG. 6, in accordance with additional embodiments of this disclosure;

FIG. 8 is a flowchart showing an example method of manufacturing the airflow control device of FIG. 1, in accordance with embodiments of this disclosure.

### DETAILED DESCRIPTION

In the Brief Summary above and in the Detailed Description, the claims below, and in the accompanying drawings, reference is made to particular features (including method acts) of the present disclosure. It is to be understood that the disclosure includes all possible combinations of such particular features. For example, where a particular feature is disclosed in the context of a particular embodiment, or a particular claim, that feature can also be used, to the extent possible, in combination with and/or in the context of other particular aspects and embodiments described herein.

The following description provides specific details, such as components, assembly, and materials in order to provide a thorough description of embodiments of the disclosure. However, a person of ordinary skill in the art will understand that the embodiments of the disclosure may be practiced without employing these specific details.

The use of the term “for example,” means that the related description is explanatory, and though the scope of the disclosure is intended to encompass the examples and legal equivalents, the use of such terms is not intended to limit the scope of an embodiment or this disclosure to the specified components, acts, features, functions, or the like.

Drawings presented herein are for illustrative purposes, and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured to” in reference to a structure or device intended to perform some function refers to size, shape, material composition, material distribution, orientation, and/or arrangement, etc., of the referenced structure or device.

As used herein, the terms “comprising” and “including,” and grammatical equivalents thereof include both open-ended terms that do not exclude additional, unrecited elements or method acts, and more restrictive terms such as “consisting of” and “consisting essentially of” and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms “a,” “an,” and “the” include the plural forms as well, unless the context clearly indicates otherwise.

As used herein, the term “and/or” includes any and all combinations of one or more of the associated listed items.

As used herein, relational terms, such as “first,” “second,” etc., are used for clarity and convenience in understanding the disclosure and accompanying drawings and does not connote or depend on any specific preference, orientation, or order, except where the context clearly indicates otherwise.

As used herein, the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the terms “smoking and/or vaporizing substance,” refers to one or more dry herbs for smoking, concentrates for smoking, and/or concentrates for vaporizing (e.g., “dab” concentrates, such as shatter, crumble, wax, budder, rosin, live resin, etc.) that are made of or include any suitable herb that can be dried and smoked, or from which smoking and/or vaporizing concentrates can be made. As non-limiting examples, “smoking and/or vaporizing substances,” may be derived from herbs, such as cannabis, tobacco, blue cornflower, blue vervain, calamus, calendula, catnip, chamomile, chrysanthemum, damiana, echinacea, eucalyptus, gotu kala, hawthorn, hibiscus, holy basil, jasmine, lavender, lemongrass, licorice root, linden, marshmallow leaf, mugwort, mullein, nettle, passionflower, peppermint, raspberry leaf, rose, sage, skullcap, saint john's wort, uva ursi, wild dagga, wormwood, violet, yarrow, yerba santa, combinations of two or more of the foregoing, etc.

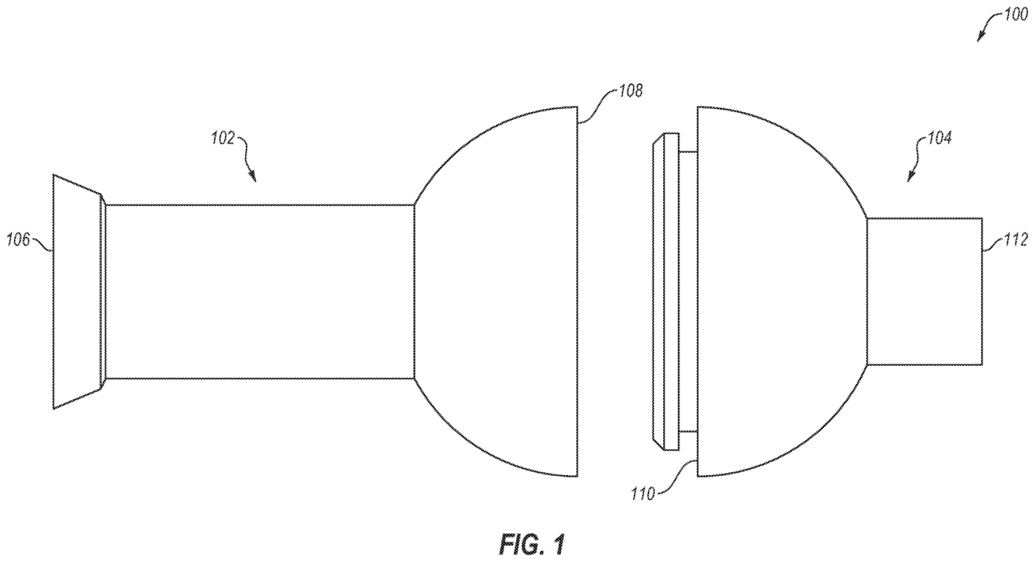

FIG. 1 shows an exploded view of an airflow control device 100. The airflow control device 100 may be utilized in the context of vaporizing and/or smoking, although the use of the airflow control device 100 is in no way limited to the vaporizing and/or smoking context. In the vaporizing and/or smoking context, the airflow control device 100 may function as what is colloquially referred to as a “carb cap.” Thus, the airflow control device 100 may be utilized to direct or restrict airflow, including vapors, and/or smoke through the airflow control device 100. The airflow control device 100 generally includes a first body 102 and a second body 104 configured to removably connect to the first body 102. The airflow control device 100 may include a plurality of second bodies. As will be discussed in further detail below, the second body 104 may be removably connect to the first body 102 to facilitate and direct airflow through the airflow control device 100.

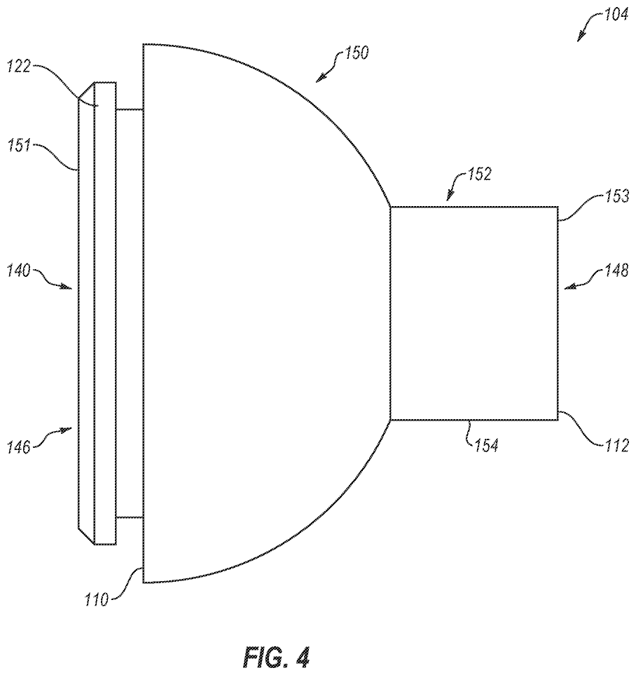

The first body 102 may be capable of removably connecting to each of the plurality of second bodies 104, such that the device can be configured (e.g., assembled) to have varying effects on airflow. The airflow control device 100 may include a disassembled state, in which the first body 102 and the second body 104 are separated from one another. In some embodiments, there may be any number of different configurations of the second body 104 such that each configuration has a different effect on airflow when connected to the first body 102. The airflow control device 100 may include at least three different assembled states, in which a different embodiment of the second body 104 is used in each assembly. The second body 104 may be configured to have a different desired effect on the flow of fluid through the airflow control device 100. In addition, the airflow control device 100 may include a fully assembled state, in which the first body 102 is removably connected to the second body 104. There may be at least three functional, fully assembled configurations (e.g., assemblies) for the airflow control device 100 that all have different desired effects on the flow of fluid through the airflow control device 100 (shown and described below with reference to FIGS. 4, 5, and 6).

The first body 102 and the second body 104 may each be made of or include any desired flexible or non-flexible material, such as one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.). The first body 102 and the second body 104 may be made from the same or different materials.

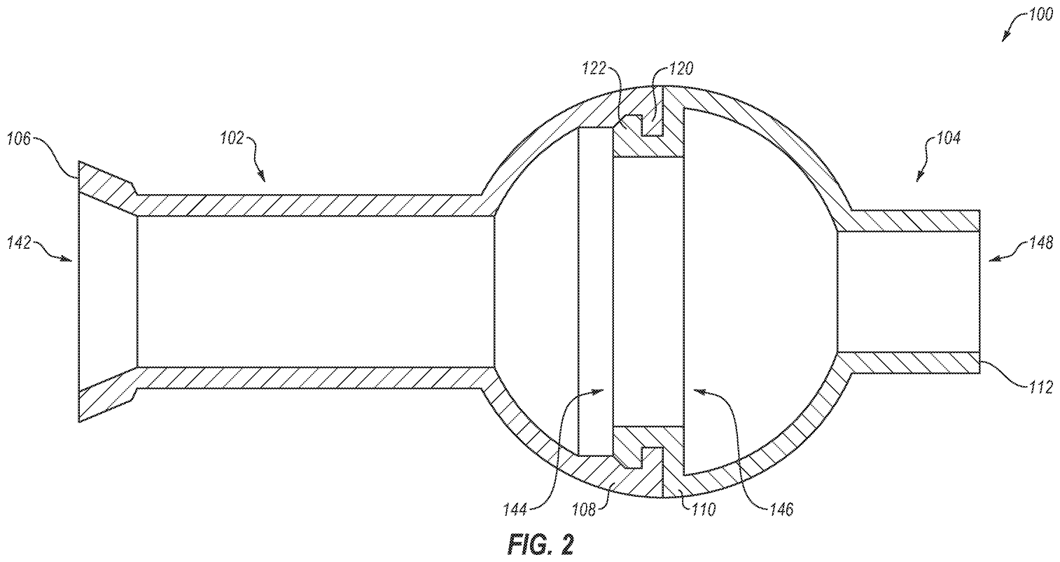

FIG. 2 is an elevational, cross-sectional view of the airflow control device 100 in the fully assembled state. The first body 102 may be configured to removably connect to the second body 104.

In some embodiments a first end 106 of the first body 102 defines a first opening 142, a second end 108 of the first body 102 defines a second opening 144, a first end 110 of the second body 104 defines a third opening 146, and a second end 112 of the second body 104 defines a fourth opening 148. The first opening 142, the second opening 144, the third opening, 146, and the fourth opening 148 may or may not be substantially aligned in an axial direction. Additionally, the first opening 142, the second opening 144, the third opening, 146, and the fourth opening 148 may all be in fluid communication and at least partially define a fluid passageway through the airflow control device 100. In some embodiments, the first end 110 of the second body 104 may be configured to removably connect to the second end 108 of the first body 102.

To facilitate the removable connections, the first body 102 may include a first connection feature 120 configured to connect to the second body 104. The second body 104 may include a second connection feature 122 configured to connect to the first body 102. The first connection feature 120 may be located at the second end 108 of the first body 102 and the second connection feature 122 may be located at the first end 110 of the second body 104. In some embodiments, the first connection feature 120 is a complimentary size, shape, etc., as the second connection feature 122. In some embodiments, each of the plurality of second bodies 104 include second connection features 122. The second connection feature 122 on the second body 104 allows the second body 104 to be configured to removably connect to the first body 102.

In some embodiments, when the airflow control device 100 is in a fully assembled state, the first connection feature 120 of the first body 102 is removably connected to the second connection feature 122 of the second body 104. When in the fully assembled state the first connection feature 120 and the second connection feature 122 for a fluid-tight seal.

The first connection feature 120 and the second connection feature 122 may exhibit any suitable size, shape, etc., to facilitate connection of the first body 102 and the second body 104. In addition, the first connection feature 120 and the second connection feature 122 may each include any suitable feature to facilitate a removable connection between the first body 102 and the second body 104. For example, the connection features 120, 122 may include threads, protrusions (e.g., ridges, pins, etc.), or openings (e.g., grooves, holes, etc.) on the first body 102 that are configured to engage with corresponding (e.g., complementary) features, such as threads, openings (e.g., grooves, recesses, etc.), protrusions (e.g., ridges, pins, etc.) on the second body 104.

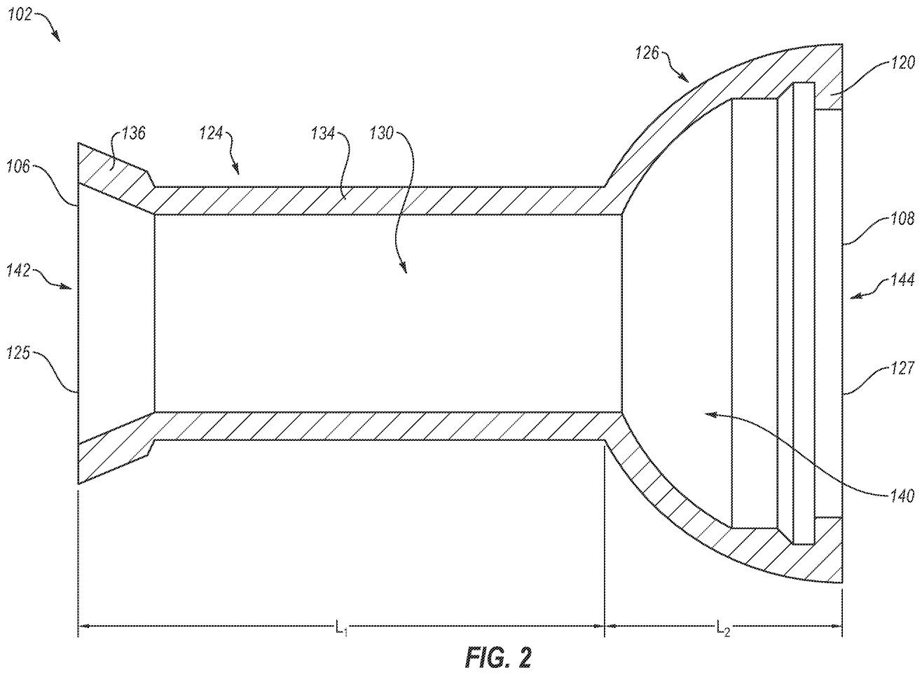

FIG. 3 is an elevational view of the first body 102 of the airflow control device 100. Referring to FIG. 3, the first body 102 may include may include a first portion 124 and a second portion 126. The first portion 124 may be a narrow portion including a first inlet 125 and the second portion 126 may be a wide portion, wider than the first portion 124, including a first outlet 127 and the first connection feature 120. The first portion 124 of the first body 102 may be configured to receive fluid from the first end 106 of the first body 102. For example, the first portion 124 of the first body 102 may at least partially define a central cavity 130 configured to at least partially define a first fluid passageway extending through the first body 102.

The first portion 124 may exhibit any desired shape. For example, the first portion 124 of the first body 102 may exhibit a spherical shape, a cylindrical tubular shape, a conical shape, a pyramid shape, a rectangular box shape, a dome shape, a chisel shape, a pillar shape, a truncated version of one of the foregoing shapes, or a combination of two or more of the foregoing shapes. In some embodiments, the first portion 124 exhibits a substantially hollow cylinder shape.

In addition, the first portion 124 may exhibit any desired dimensions, including any desired lateral dimensions (e.g., in the X-direction and Z-direction) and any desired longitudinal dimensions (e.g., in the Y-direction).

The first portion 124 may include an outer wall 134 and a flange portion 136 at the first end 106 of the first body 102. The outer wall 134 may extend from the flange portion 136 to the second end 108 of the first body 102. The flange portion 136 may be configured to direct fluid through the first portion. Interior surfaces of the outer wall 134 and the flange portion 136 may at least partially define the first fluid passageway within the first body 102. The size and shape of the outer wall 134 and the flange portion 136 may determine the size and shape of the first fluid passageway. In some embodiments, the portion of the first fluid passageway defined by the first portion 124 may exhibit a size and shape complementary to the size and shape of at least a portion of first fluid passageway defined by the second portion 126 of the first body 102.

The first body 102 may further include the second portion 126 adjacent to the first portion 124. The second portion 126 may at least partially define a cavity 140 in the airflow control device 100. The second portion 126 may also be in fluid communication with the first portion 124 and at least partially define the first fluid passageway through the first body 102. Additionally, the second portion 126 may define the second end 108 of the first body 102.

The second portion 126 may exhibit any desired tubular shape. For example, the second portion 126 of the first body 102 may exhibit a half-dome shape, a hollow spherical shape, a hollow cylindrical shape, a hollow conical shape, a hollow pyramid shape, a hollow rectangular box shape, a truncated version of one of the foregoing shapes, or a combination of two or more of the foregoing shapes. In some embodiments, the second portion 126 exhibits a substantially hollow cylinder shape.

During assembly and disassembly of the airflow control device 100, the first body 102 may be manipulated into alternate geometries. Once the airflow control device 100 is assembled or disassembled, the first body 102 may return to its original configuration. In some embodiments, the first portion 124 and the second portion 126 may include a flexible material and the manipulation of the first portion 124 and the second portion 126 of the first body 102 may include stretching, compressing, folding etc., at least part of the first portion 124 and/or the second portion 126. In additional embodiments, the first body 102 may include a rigid material and may include features to facilitate manipulation of the first body 102 relative to itself or any other element of the airflow control device 100 for assembly or disassembly. Such features may include, for example, hinges, threaded portions, clips, etc. To facilitate assembly and disassembly of the airflow control device 100, the flange portion 136 may also be flexible relative to the outer wall 134 of the first portion 124.

The first portion 124 and the second portion 126 of the first body 102 may be made of or include any desired material. The first portion 124 and the second portion 126 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.).

In addition, the second portion 126 may exhibit any desired dimensions, including any desired lateral dimensions (e.g., in the Y-direction and Z-direction) and any desired longitudinal dimensions (e.g., in the X-direction). For example, the second portion 126 may exhibit a length L₂ in a longitudinal direction (e.g., along the X-direction) that is within a range of from about 1.5 times to about 10 times, such as from about 3 times to about 7 times (e.g., about 5 times) less than L₁, the lateral dimensions (e.g., in the X-direction) of the first portion 124. In certain embodiments, the length L₂ of the second portion may be from about 0.25 inches to about 2 inches, such as about 0.5 inches. Additionally, the diameter of the first opening 142 may be smaller than the diameter of the second opening 144. The dimensions of the second opening 144 may be within a range from 1.5 times to 5 times larger than the dimensions of the first opening 142.

The second portion 126 may be made of or include any desired materials. For example, the second portion 126 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.).

In some embodiments, the first body 102 comprises a unitary structure that includes both the first portion 124 and the second portion 126. In additional embodiments, the first portion 124 and the second portion 126 are formed separately and combined together. The first portion 124 may be made of or include a first material that may be the same as or different than a second material of the second portion 126. In embodiments in which the first portion 124 includes a different material than the second portion 126, the first portion 124 and the second portion 126 may be configured to be coupled together using a fastener, for example, a threaded connection, a clip type connection, a pin, etc. Accordingly, the first body 102 may include continuous fluid passageways regardless of the materials and manufacturing processes of the first portion 124 and the second portion 126.

FIGS. 4-7 are elevational views of various embodiments of the second body 104 of the airflow control device 100. The second body 104 may include a first portion 150 and a second portion 152. The second body 104 may include a wide portion including a second inlet 151 and the second connection feature 122 and a narrow portion including the second outlet 153. Referring to FIG. 4, the first portion 150 may include the second connection feature 122 at the first end 110 and the first portion 150 of the second body 104 may be configured to removably connect to the second portion 126 of the first body 102.

The first portion 150 may exhibit any desired shape and size. For example, the first portion 150 of the second body 104 may exhibit a spherical shape, a cylinder shape, a conical shape, a pyramid shape, a rectangular box shape, a dome shape, a chisel shape, a pillar shape, a truncated version of one of the foregoing shapes, or a combination of two or more of the foregoing shapes. In some embodiments, the first portion 150 of the second body 104 may exhibit a similar shape and size (e.g. a hollow spherical shape, a hollow cylindrical shape,) as the second portion 126 of the first body 102. In additional embodiments, the first portion 150 of the second body 104 may at least partially define the cavity 140 in the airflow control device 100.

The first portion 150 of the second body 104 and the second portion 126 of the first body 102 may be substantially the same shape or may be substantially different shapes. In some embodiments, when the first body 102 and the second body 104 are connected the second portion 126 of the first body 102 and the first portion 150 of the second body 104 for the cavity 140 for fluid to be contained therein. The cavity 140 serves as in intermediate fluid chamber for fluid (e.g. air, gas, etc.) to aid in regulating temperature change from one end of the airflow control device 100 to another end. The cavity 140 slows the flow of fluid through the airflow control device 100 from a lower temperature, ambient environment to a higher temperature, enclosed combustion area of a smoking device or vice versa.

The first portion 150 of the second body 104 may be made of or include any desired material. The first portion 150 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.).

The second body 104 may further include the second portion 152 adjacent to the first portion 150. The second portion 152 may include an additional stem 154 connected to and extending away from the first portion 150 of the second body 104. The second portion 152 (e.g., the additional stem 154) may be in fluid communication with the first portion 150.

The second portion 152 (e.g., the additional stem 154) may exhibit any desired tubular shape. For example, the second portion 152 of the second body 104 may exhibit a hollow cylinder shape, a hollow conical shape, a hollow helical shape a hollow pyramid shape, a hollow rectangular box shape, a truncated version of one of the foregoing shapes, or a combination of two or more of the foregoing shapes. In some embodiments, the second portion 152 exhibits a substantially hollow cylinder shape.

The lateral dimensions (e.g., in the Y-direction and Z-direction) of the second portion 152 may correspond to the size of the first opening 142 of the first body 102 such that the second portion 152 may removably connect to the second portion 126 of the first body 102. In addition, the second portion 152 may exhibit any desired longitudinal dimensions (e.g., in the X-direction). For example, the second portion 152 may exhibit a length L₂ in a longitudinal direction (e.g., along the X-direction) that is within a range of from about 0.5 times to about 2 times, such as from about 0.75 times to about 1.5 times greater than the lateral dimensions (e.g., in the X-direction or Z-direction) of the first portion 150. In certain embodiments, the length L₂ of the second portion may be from about 0.25 inches to about 1 inch, such as about 0.5 inches.

The second body 104 may at least partially define the second fluid passageway extending through the second body 104 from the third opening 146 to the fourth opening 148. As shown in FIG. 4, the second portion 152, which includes the additional stem 154 extends away from the first portion 150 substantially in the X-direction, such that the first fluid passageway and the second fluid passageway form a substantially linear pathway through the airflow control device.

The second portion 152 may be made of or include any desired materials. For example, the second portion 152 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.).

In some embodiments, the second body 104 comprises a unitary structure that includes both the first portion 150 and the second portion 152. In additional embodiments, the first portion 150 and the second portion 152 are formed separately and combined together. The first portion 150 may be made of or include a first material that may be the same as or different than a second material of the second portion 152. In embodiments in which the first portion 150 includes a different material than the second portion 152, the first portion 150 and the second portion 152 may be configured to be coupled together using a fastener, for example, a threaded connection, a clip type connection, a pin, etc. Accordingly, the second body 104 may include continuous fluid passageways regardless of the materials and manufacturing processes of the first portion 150 and the second portion 152. In addition, the continuous fluid passageways of the second body 104 may be aligned with the continuous fluid passageways of the first body 102 when the airflow control device 100 is partially or fully assembled.

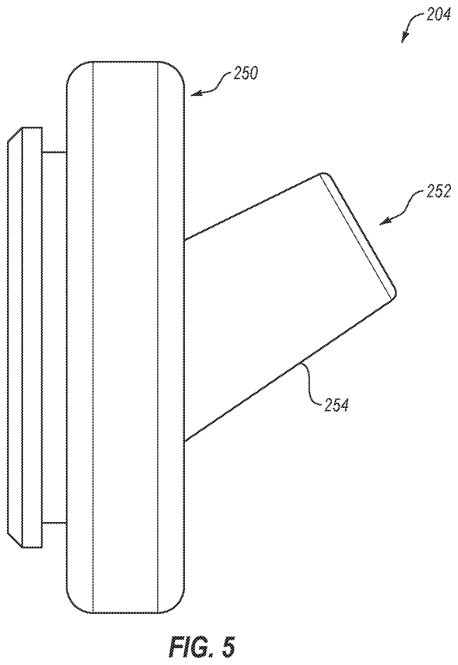

FIG. 5 shows an additional embodiment of a second body 204. The second body includes a first portion 250 and a second portion 252. The first portion 250 may exhibit any desired shape and size. For example, the first portion 250 of the second body 204 may exhibit a spherical shape, a cylinder shape, a conical shape, a pyramid shape, a rectangular box shape, a dome shape, a chisel shape, a pillar shape, a truncated version of one of the foregoing shapes, or a combination of two or more of the foregoing shapes. In some embodiments, the first portion 250 of the second body 204 may exhibit a similar shape and size (e.g. a hollow spherical shape, a hollow cylindrical shape,) as the second portion 126 of the first body 102.

The second portion 252 (e.g., an additional stem 254) may exhibit any desired tubular shape. For example, the second portion 252 of the second body 204 may exhibit a hollow cylinder shape, a hollow conical shape, a hollow helical shape a hollow pyramid shape, a hollow rectangular box shape, a truncated version of one of the foregoing shapes, or a combination of two or more of the foregoing shapes. In some embodiments, the second portion 252 exhibits a substantially hollow cylinder shape.

The first portion 250 and the second portion 252 of the second body 204 may be made of or include any desired material. The first portion 250 and the second portion 252 may include one or more metals (e.g., stainless steel, titanium, aluminum, metal alloys, etc.), glasses (e.g., soda-lime, borosilicate, fiberglass, aluminosilicate, non-silicate, etc.), ceramics (e.g., quartz, aluminum oxide, clay, porcelain, etc.), polymers (e.g., hemp, shellac, amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and/or composites (e.g., metal matrix composites, ceramic matrix composites, reinforced plastics (e.g., fiberglass), composite wood, etc.).

The second portion 252 includes the additional stem 254. The additional stem 254 may at least partially define the second fluid passageway extending through the second body 204. The second portion 252, which includes the additional stem 254 extends away from the first portion 250 substantially in the X-direction, such that the first fluid passageway and the second fluid passageway form a substantially non-linear pathway through the airflow control device. In some embodiments, the additional stem 254 may extend such that the angle of the center line of the additional stem 254 forms about a 45 degree angle with respect to the Y-Z plane. In other embodiments, the angle of the center line of the additional stem 254 with respect to the Y-Z plane may be within a range from 0 degrees to 90 degrees. The specific angle may be chosen such that the airflow control device will direct the flow of fluid in a desired direction.

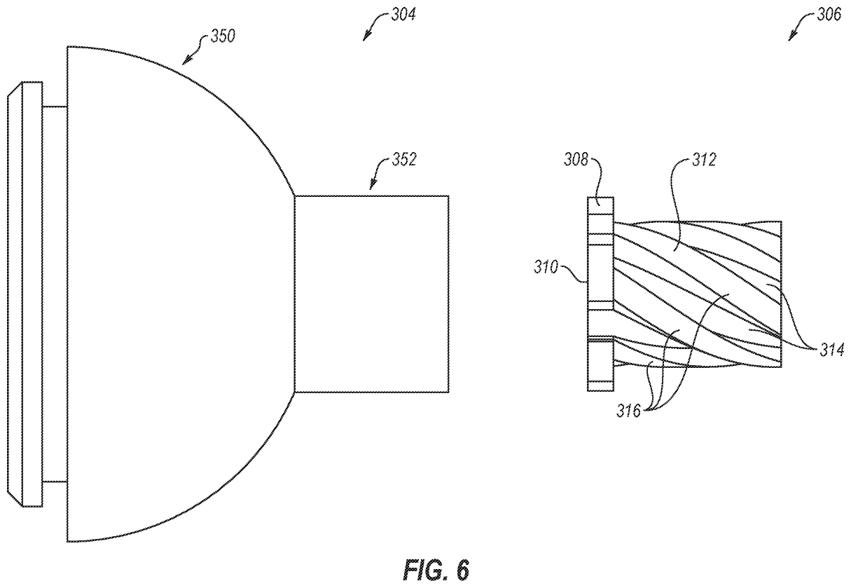

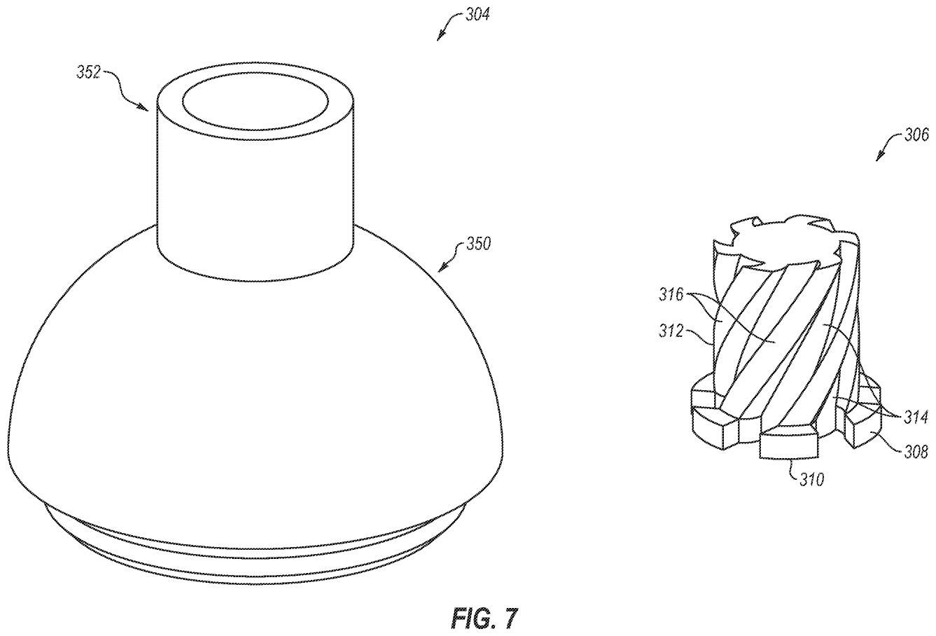

FIGS. 6 and 7 show an additional embodiment of a second body 304. The second body 304 includes a first portion 350 and a second portion 352. The second body 304 may also include a third body 306 configured to be at least partially received within the second portion 352 of the second body 304. The third body 306 may be configured to further restrict the flow of fluid through the second body 304 and may exhibit any desired shape and size. For example, the third body 306 may exhibit a cylindrical shape, a spherical shape, a conical shape, a pyramid shape, a rectangular box shape, a dome shape, a chisel shape, a pillar shape, a truncated version of one of the foregoing shapes, or a combination of two or more of the foregoing shapes. In some embodiments the third body 306 is substantially cylindrical.

The third body 306 may include a flange 308 at a first end 310 of the third body 306. The flange 308 may have a larger diameter than an outer surface 312 of the third body 306. The flange 308 may be configured to prevent the third body 306 from passing all the way through the second portion 352 of the second body 304

Additionally, the outer surface 312 may extend from a first end of the third body 306 to a second end of the third body 306. The third body 306 may include a plurality of grooves 314 on the outer surface. The plurality of grooves 314 may further define a fluid passageway through the second body 304. In some embodiments, the plurality of grooves 314 may exhibit any desired shape and size. In some embodiments the plurality of grooves 314 may further include and be defined by helical blades 316 around the circumference of the third body 306. The plurality of grooves may be configured to direct the flow of fluid in a swirling motion as it exits the second portion 352 of the second body 304.

The region between the first portion 350 of the second body 304 and the second portion 352 of the second body 304 may include a transition that includes a hard step, a gradual transition, a ramp, a transition with a curved profile, etc., or any combination of the foregoing. The transition may be configured to receive the flange 308 and prevent the third body 306 from passing through the second portion 352. The inner diameter of the second portion 352 of the second body 304 may be substantially the same as the outer diameter of the third body 306 to facilitate the assembly of the second body 304 and the third body 306. The inner diameter of the second portion 352 being substantially the same as the outer diameter of the third body 306 may also facilitate a substantially air-tight connection between the second body 304 and the outer surface 312 of the third body 306.

The disclosed embodiments of the second body, 104, 204, 304, and any additional embodiments may be configured to be positioned at least partly within and at least partially occlude an opening of a smoking apparatus.

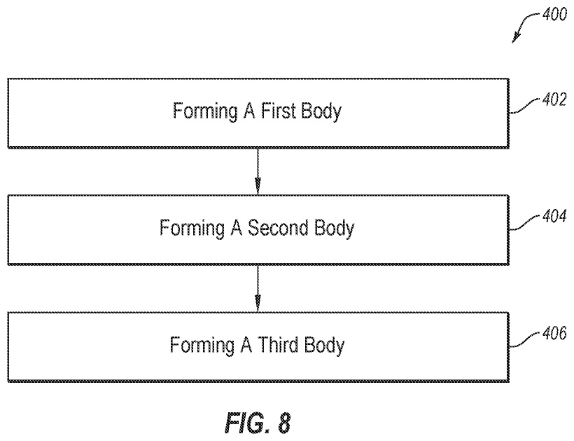

FIG. 8 is a flowchart showing an example method of manufacturing an airflow control device 400. The method of manufacturing the airflow control device 400 may include forming a first body, as shown in act 402. The first body may include a first end defining a first opening, a second end opposite the first end, the second end defining a second opening, and a first connection feature at the second end. The first body may also define a first fluid passageway from the first opening to the second opening.

The method of manufacturing the airflow control device 400 may include forming a second body, as shown in act 404. The second body may include a first end defining a third opening, a second end defining a fourth opening, and a second connection feature at the first end, the second connection feature configured to connect to the first connection feature of the first body. The second body may also define a second fluid passageway from the third opening to the fourth opening.

In some embodiments, the method of manufacturing the airflow control device 400 may further include forming a third body, as shown in optional act 406. The third body may include a first end, a second end opposite the first end, an outer surface extending from the first end to the second end, and a plurality of grooves on the outer surface.

The forming of any of the elements described above may include any one of or any combination of the following manufacturing processes. Additive manufacturing may be utilized in which components may be formed by depositing material, layer upon layer, in precise geometric shapes. Some examples of additive manufacturing include injection molding, powder bed fusion, binder jetting, direct energy deposit, material extrusion, material jetting, sheet lamination, vat polymerization, etc. Additionally, traditional manufacturing methods may be utilized such as turning, boring, milling, shaping, broaching, slotting, grinding etc.

The airflow control devices of the embodiments described above may allow a single device to be used for multiple types of smoking and/or vaporizing substances. For example, airflow control devices described above may include a first configuration and/or position that can be used for smoking (e.g., combusting dry herbs), and one or more additional configurations and/or positions that can be used for vaporizing concentrates. In addition to multiple uses in operation, the airflow control devices previously described may also be used for storing smoking and/or vaporizing substances. Accordingly, the airflow control devices described herein may be relatively small and compact, providing for easier travel that traditional devices intended to perform a single function.

While embodiments of this disclosure have been described and illustrated herein with respect to specific airflow control devices, those of ordinary skill in the art will recognize and appreciate that features and elements from different embodiments may be combined to arrive at further, additional airflow control devices and methods as contemplated by the inventors.

What is claimed is:

1. An airflow control device, comprising:
a first body defining a first fluid passageway extending through the first body, the first body comprising:
a first end including a first portion defining a first opening;
a second end opposite the first end, the second end including a second portion defining a second opening;
a connection feature at the second end; and
a plurality of second bodies configured to removably connect to the connection feature at the second end of the first body.

2. The airflow control device of claim 1, wherein the first portion of the first body exhibits a cylindrical tubular shape, and the second portion of the first body exhibits a half-dome shape.

3. The airflow control device of claim 1, further comprising a flange at the first end of the first body, the flange configured to direct fluid through the first portion.

4. The airflow control device of claim 1, wherein the first body and the plurality of second bodies are made from the same material.

5. The airflow control device of claim 1, wherein each of the plurality of second bodies further comprise:
a first end defining a third opening;
a second end defining a fourth opening;
a connection feature at the first end; and
wherein the second body defines a second fluid passageway from the third opening to the fourth opening.

6. The airflow control device of claim 1, wherein the first opening has a first diameter and the second opening has a second diameter that is the larger than the first diameter.

7. The airflow control device of claim 1, further comprising:
a third body configured to be received within a portion of at least one of the plurality of second bodies; and
wherein the third body further restricts flow of fluid.

8. The airflow control device of claim 1, wherein the first body comprises a flexible material.

9. The airflow control device of claim 8, wherein the first body comprises silicone.

10. The airflow control device of claim 1, wherein the connection feature comprises a ridge configured to separately engage a complementary recess of each of the plurality of second bodies.

11. An airflow control device, comprising:
a first body exhibiting a tubular shape, the first body including a first inlet, a first outlet, and a first connection feature; and
a plurality of second bodies exhibiting a tubular shape, each of the plurality of second bodies including a second inlet, a second outlet, and a second connection feature configured to removably connect to the first connection feature.

12. The airflow control device of claim 11 further comprising a third body exhibiting a cylindrical shape, the third body including an outer surface extending from a first end of the third body to a second end of the third body, wherein the third body is configured to be received within a portion of at least one second body of the plurality of second bodies.

13. The airflow control device of claim 11, wherein the first connection feature of the first body is removably connected to the second connection feature of the second body.

14. The airflow control device of claim 13, wherein the second connection feature and the first connection feature form fluid-tight seal.

15. The airflow control device of claim 13, wherein the second body is configured to be positioned at least partly within and at least partially occlude an opening of a smoking apparatus.

16. The airflow control device of claim 11, wherein one of the plurality of second bodies further comprises a third body including helical blades, the third body configured to be received within the second body proximate the second portion.

17. The airflow control device of claim 11, wherein:
the first body comprises:
a narrow portion including the first inlet; and
a wide portion including the first outlet and the first connection feature; and
each of the plurality of second bodies comprises:
a wide portion including the second inlet and the second connection feature; and
a narrow portion including the second outlet.

18. A method of forming an airflow control device, the method comprising:
forming a first body, comprising:
a first end defining a first opening;
a second end opposite the first end, the second end defining a second opening;
a first connection feature at the second end;
wherein the first body defines a first fluid passageway from the first opening to the second opening; and
forming a second body, comprising:
a first end defining a third opening;
a second end defining a fourth opening; and
a second connection feature at the first end, the second connection feature configured to connect to the first connection feature of the first body;
wherein the second body defines a second fluid passageway from the third opening to the fourth opening.

19. The method of claim 18, further comprising forming a third body, comprising:
a first end;
a second end opposite the first end;
an outer surface extending from the first end to the second end; and
a plurality of grooves on the outer surface.

20. The method of claim 18, wherein the first body and the second body are formed through additive manufacturing.
